(19) United States
(12) Patent Application Publication
(10) Pub. No.: US 2002/0147589 A1
(43) Pub. Date: Oct. 10, 2002

(54) Graphic display device with built-in speech recognition function

(75) Inventor: Youichi Itaki, Tokyo (JP)

Correspondence Address: SUGHRUE MION, PLLC, 2100 PENNSYLVANIA AVENUE, N.W., WASHINGTON, DC, 20037, US

(73) Assignee: NEC VIEWTECHNOLOGY, Ltd.

(21) Appl. No.: 10/113,560

(22) Filed: Apr. 2, 2002

(30) Foreign Application Priority Data
Apr. 4, 2001 (JP) 105652/2001

(51) Int. Cl. G10L 13/08

(52) U.S. Cl. 704/260

(57) ABSTRACT

There is provided a graphic display device with a built-in speech recognition function, by which electronic presentations can be given without being affected by external factors such as changes in surrounding noises or the way the presenter produces speech. The graphic display device comprises a speech display signal generating section for recognizing speeches inputted from a microphone and generating speech display signals and an image display signal generating circuit for processing image inputs to generate image display signals, and displays the speech display and image display in combination on a screen. The graphic display device further comprises a CPU and a memory control circuit for controlling memories of both the speech and image displays to synchronize the displays.

### FIELD OF THE INVENTION

The present invention relates to a graphic display device for use with a computer etc. in a presentation where computerized materials are shown in turn (hereinafter referred to as an electronic presentation), and more particularly to a graphic display device with a built-in speech recognition function which improves communicability of the electronic presentation and installability of the system.

### BACKGROUND OF THE INVENTION

Graphic display devices, such as projectors are used in electronic presentations. In the electronic presentation, the graphic display device is connected to a computer or the like, and an operator (speaker) shows electronic materials in turn by the display device while making a presentation. When the electronic presentation is given to a large audience, the operator might have to use a loudspeaker system etc. according to the circumstances.

FIG. 1 is a diagram showing the configuration of a system including a conventional graphic display device. As shown in FIG. 1, the conventional system for electronic presentations comprises a graphic display device 1A, a screen 2, a computer 3, a video 4, a microphone 6, and a speaker 8. Generally, the graphic display device (projector) 1A is connected to the computer 3 and the video 4, and materials are displayed on the screen 2 set at a prescribed distance from audiences 7. The microphone 6 is located near an operator (speaker), and his/her speech is delivered to the audiences 7 through the speaker 8.

Besides, there are known recent techniques for displaying the content of speech using a speech recognition device, or for outputting the content on a printer using a voice data/character code converter. For example, Japanese Patent Application laid open No. HEI9-330096 (reference 1) discloses voice note equipment for automobile use, in which user's speech is converted into a simple character string (text) with a speech recognition technique, and the text is displayed on an information display unit such as a liquid crystal display (LCD).

Other examples are known from Japanese Patent Application laid open No. HEI10-282970 (reference 2) and Japanese Patent Application laid open No. HEI10-250392 (reference 3). Reference 2 discloses a voice information display unit for displaying voice inputs from a microphone on the screen of a karaoke machine or video lecture equipment in combination with screen images. Reference 3 discloses remote lecture equipment for giving a tele-lecture with the use of a projector, in which outputs from various types of media devices are switched by a voice input.

In the above system using a graphic display device shown in FIG. 1, a means for communicating operator's speech is easily affected by external factors. Consequently, there may be some situations where it is hard to hear the operator's speech depending on changes in surrounding noises or how the operator produces speech (pronunciation, speed, etc.). Moreover, since the system includes many pieces of equipment such as a speaker, it is troublesome to transport and set up the system. To put it differently, the pieces of equipment necessary for the electronic presentation are typically carried to a place where presentations are given and connected to each other. This is a troublesome task. Besides, with the conventional graphic display device, it is difficult to give electronic presentations to people with hearing difficulties because the means for communicating operator's speech only resorts to the hearings.

Additionally, the voice note equipment of reference 1 is not provided with the function of a projector, and only represents the content of voice inputs in characters on a display such as an LCD. The equipment is effective in taking notes while driving a car, but incapable of displaying pictures on a screen for a large audience.

The voice information display unit of reference 2, which is applied to karaoke machines and video lecture equipment, does not have the function of a projector, either. In addition, it is necessary to manipulate a remote controller and a timer to operate the unit, which makes the operation even harder.

On the other hand, the remote lecture equipment of reference 3 is provided with a projector. However, the equipment requires an Internet connection and various multimedia devices in addition to the projector, which limits the location of the equipment as well as making transportation more inconvenient.

### SUMMARY OF THE INVENTION

It is therefore an object of the present invention to provide a graphic display device (including a projector or the like) with a built-in speech recognition function for use in electronic presentations, by which the electronic presentations can be given without being affected by external factors such as changes in surrounding noises or the way the operator (speaker) produces speech (pronunciation, speed, etc.).

It is another object of the present invention to provide a graphic display device with a built-in speech recognition function, which can reduce necessary devices for use in an electronic presentation so as to lighten the workload of transporting the devices and setting operation such as connecting codes.

It is still another object of the present invention to provide a graphic display device with a built-in speech recognition function, which realizes more expressive electronic presentations as well as enabling the electronic presentations to be given for people with hearing difficulties, and thus increasing the number of people who can participate in the electronic presentations.

In accordance with the present invention, to achieve the above object, there is provided a graphic display device with a built-in speech recognition function, which converts inputted speech to character codes (text) and displays the text in combination with a screen image, comprising: a speech display signal generating section for recognizing speech inputted from a microphone and generating a speech display signal; an input image signal processing circuit for converting plural image inputs from analog to digital; an image display memory for storing a digital image signal obtained at the input image signal processing circuit; an image display signal generating circuit for reading the digital image signal stored in the image display memory and generating an image display signal; a display signal combining circuit for combining the speech display signal outputted from the speech display signal generating section and the image display signal outputted from the image display signal generating circuit; a CPU for controlling each circuit based on a program; a memory control circuit for controlling the image display memory and the speech display signal generating section under the control of the CPU; and a display section for displaying outputs from the display signal combining circuit on a screen.

The speech display signal generating section of the graphic display device according to the present invention may include: a speech input terminal that is connected to the microphone; a speech recognition circuit for recognizing an audio signal inputted to the speech input terminal and converting the signal to character code data; a text buffer circuit for storing the character code data of the characters as a character string (text); a font ROM for storing fonts; a text display memory for converting the character code data to text display data and storing the data; and a text display signal generating circuit for reading the text display data stored in the text display memory and generating a text display signal. Each of the circuits are connected through buses, and thereby controlled by the CPU and the memory control circuit.

In accordance with another aspect of the present invention, the CPU accesses to the font ROM when the text buffer circuit is supplied with the character code data to convert the character code data to character pattern data, and feeds the data to the text display memory.

In accordance with another aspect of the present invention, the memory control circuit controls the image display memory and the text display memory so that speech text (speech that is converted into text) is synchronized with a screen image.

In accordance with another aspect of the present invention, the speech display signal generating section includes plural speech input terminals so that speeches of plural speakers can be independently displayed in characters on the screen.

In accordance with yet another aspect of the present invention, the speech display signal generating section may include plural speech recognition circuits and text buffer circuits corresponding to the plural speech input terminals so that conversations of the plural speakers can be displayed in the form of dialogue.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the configuration of a system including a conventional graphic display device;

FIG. 2 (A) is a block diagram showing the configuration of a system including a graphic display device according to the first embodiment of the present invention;

FIG. 2 (B) is a diagram showing a front view of a screen of the graphic display device;

FIG. 3 is a diagram showing the circuitry of the graphic display device shown in FIG. 2 (A);

FIG. 4 (A) is a diagram illustrating an example of horizontal display on the screen of FIG. 2 (B);

FIG. 4 (B) is a diagram illustrating another example of horizontal display on the screen of FIG. 2 (B);

FIG. 5 (A) is a diagram illustrating an example of vertical display on the screen of FIG. 2 (B);

FIG. 5 (B) is a diagram illustrating another example of vertical display on the screen of FIG. 2 (B);

FIG. 6 is a diagram illustrating another example of horizontal display on the screen of FIG. 2 (B);

FIG. 7 (A) is a block diagram showing the configuration of a system including a graphic display device according to the second embodiment of the present invention; and

FIG. 7 (B) is a diagram showing a front view of a screen of the graphic display device.

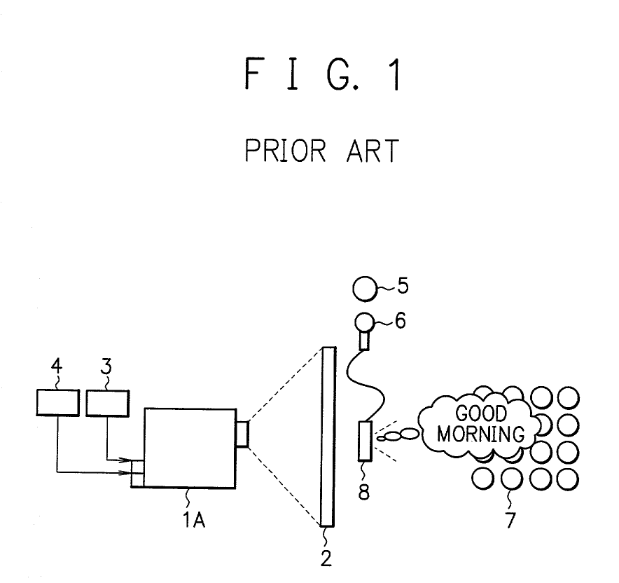

### DESCRIPTION OF THE PREFERRED EMBODIMENT

Referring now to the drawings, a description of a preferred embodiment of the present invention will be given in detail.

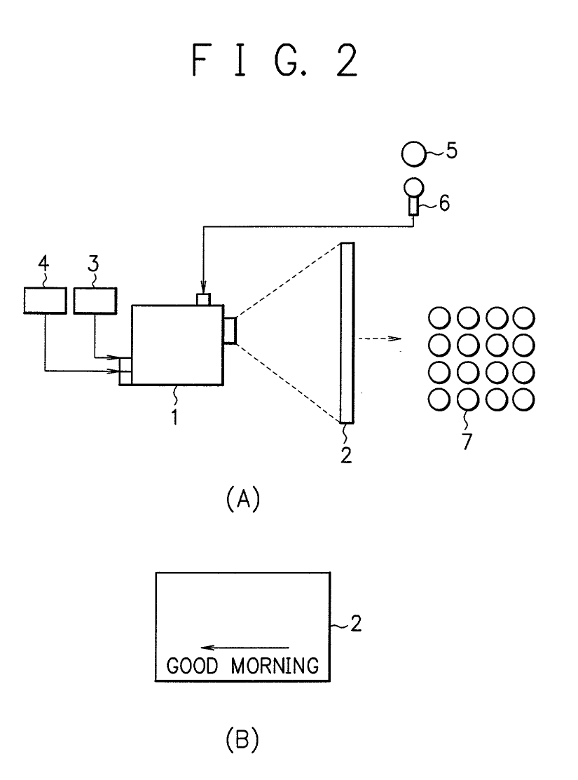

FIGS. 2 (A) and (B) are diagrams illustrating the configuration of a system including a graphic display device according to the first embodiment of the present invention and a front view of a screen of the graphic display device, respectively. As shown in FIGS. 2 (A) and (B), in this embodiment, the system for electronic presentations comprises: a graphic display device 1, a screen 2, a computer 3, a video 4, and a microphone 6. The graphic display device 1 is connected to the computer 3 and the video 4, and displays images on the screen 2 that audiences 7 can view. The microphone 6 is connected to the graphic display device 1. When an operator (speaker) 5 inputs voice information, for example, “GOOD MORNING,” to the graphic display device 1 via the microphone 6, it is converted to text data by a speech recognition function, and text “GOOD MORNING” is displayed somewhere on the screen 2. In FIG. 2 (B), the text appears from right to left at the bottom of the screen 2.

Accordingly, the electronic presentation can be given without a speaker etc., which facilitates transportation and setting of the system. Besides, the text representation assures a constant communicability as an auxiliary means of communication when it is hard to hear operator's speech due to external factors such as changes in surrounding noises or the way the operator 5 produces the speech (pronunciation, speed, etc.). Furthermore, it is possible to produce visual effects on the speech.

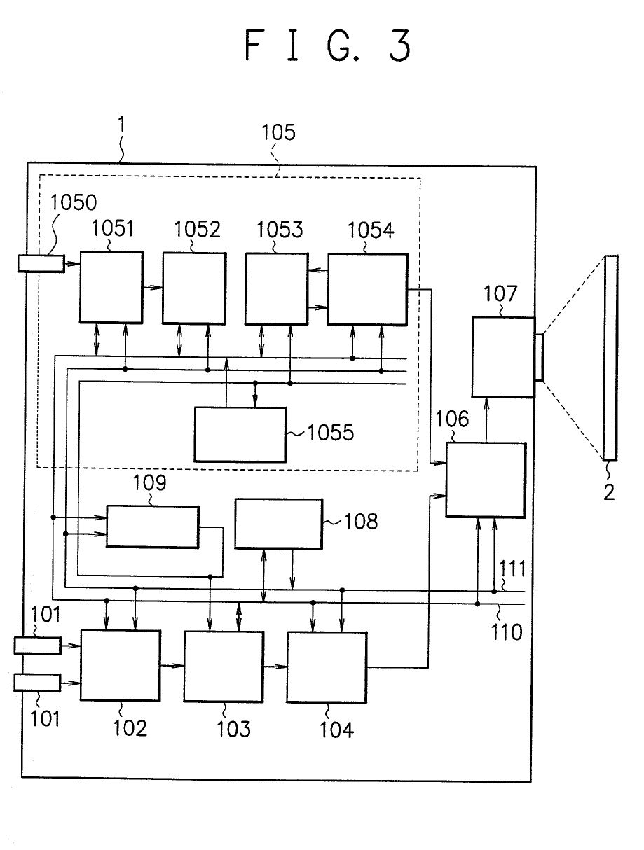

FIG. 3 is a diagram showing the circuitry of the graphic display device shown in FIG. 2 (A). The graphic display device (projector) 1 is a projection graphic display device, which is capable of extended projection to display large-sized images on the screen 2.

Referring to FIG. 3, the projector 1 includes: plural image input terminals 101 for inputting image signals from the computer 3 etc.; an input image signal processing circuit 102 for converting the image signal fed via the plural image input terminals 101 from analog to digital; an image memory 103 for storing the image signal digitalized at the input image signal processing circuit 102 as image display data; an image display signal generating circuit 104 for reading the image display data out of the image memory 103 and generating an image display signal; a speech display signal generating section 105 (shown by a dotted line) for converting an audio signal into a text display signal; a display signal combining circuit 106 for combining the image display signal fed from the image display signal generating circuit 104 and the text display signal fed from the speech display signal generating section 105 to generate a definitive display signal; a display section 107 for displaying outputs from the display signal combining circuit 106; a CPU 108 for controlling all circuits in the projector 1 through a control bus 110 and a data bus 111 based on a program included therein; and a memory control circuit 109 for controlling the memories in the projector 1.

Notably, the memory control circuit 109 controls the image memory 103 and the speech display signal generating section 105 under the control of the CPU 108 so that every speech text is displayed synchronously with a prescribed screen image in a convincing way.

Incidentally, the display section 107 includes a display device, an optical lens, an illuminant lamp, and the like. A liquid crystal device or a DLP (Digital Light Processing) device is generally used as the display device. The image on the display device is enlarged and projected on the screen 2.

The speech display signal generating section 105 includes: a speech input terminal 1050 for inputting an audio signal from the microphone 6; a speech recognition circuit 1051 for recognizing the audio signal fed via the speech input terminal 1050 and converting the signal to character codes; a text buffer circuit 1052 for storing the character codes fed from the speech recognition circuit 1051; a text display memory 1053 for storing the character codes from the text buffer circuit 1052 as text display data; a text display signal generating circuit 1054 for reading the text display data stored in the text display memory 1053 and generating a text display signal; and a font ROM 1055 for storing character pattern data corresponding to the character codes stored in the text buffer circuit 1052.

Each of the circuits is connected through the control bus 110 and the data bus 111. The text display memory 1053 storing the text display data and the font ROM 1055 storing fonts are controlled by the memory control circuit 109 along with the image memory 103 so that speech text is synchronized with a screen image. In addition, when the CPU instructs the memory control circuit 109 to switch images, the circuit 109 first checks that there is no data stored in the text display memory 1053 before switching images.

The projector 1 generally projects enlarged images fed as signals from a computer or an external video device via image input terminals 101 on the screen 2. In the following, it will be given of an outline of the operation to process the image signals. First, an image signal is fed from an external video device to the input image signal processing circuit 102 via the image input terminal 101. The image signal is converted from analog to digital at the input image signal processing circuit 102. In this manner, image signals are sequentially converted from analog to digital. Next, the digitalized image signal is stored in the image memory 103 as image display data. Accordingly, the data stored in the image memory 103 is replaced by the next digitalized image display data each time an image signal is inputted through the image input terminal 101. After that, the image display signal generating circuit 104 sequentially reads the image display data out of the image memory 103 and generates an image display signal. The image display signal is fed to the display signal combining circuit 106.

In the following, the operation of the speech display signal generating section 105 will be explained. When an audio signal is fed from the microphone 6 to the speech recognition circuit 1051 via the speech input terminal 1050 by the operator 5, the audio signal is recognized as characters and converted to character code data with respect to each single character at the speech recognition circuit 1051. The coded audio signal is stored in the text buffer circuit 1052. Subsequently, the CPU 108 converts the character code data to character pattern data by using the font ROM 1055. The character pattern data are stored in the text display memory 1053 as text display data. The text display signal generating circuit 1054 reads the text display data out of the text display memory 1053, and generates a text display signal outputted as text. The text display signal is outputted to the display signal combining circuit 106. In addition, the text display signal generating circuit 1054 is supplied with control data for controlling text display data read position or text display output position so that display type and display position of text can be changed.

Next, the display signal combining circuit 106 combines the image display signal fed from the image display signal generating circuit 104 and the text display signal fed from the text display signal generating circuit 1054 to generate an integrated display signal so that text is displayed on a screen image in combination. The display signal is supplied to the display section 107 to be enlarged and projected on the screen 2 as a display image of the projector 1. As a result, speeches inputted from the speech input terminal 1050 are displayed one after another together with a corresponding screen image of an image signal inputted via the image input terminal 101.

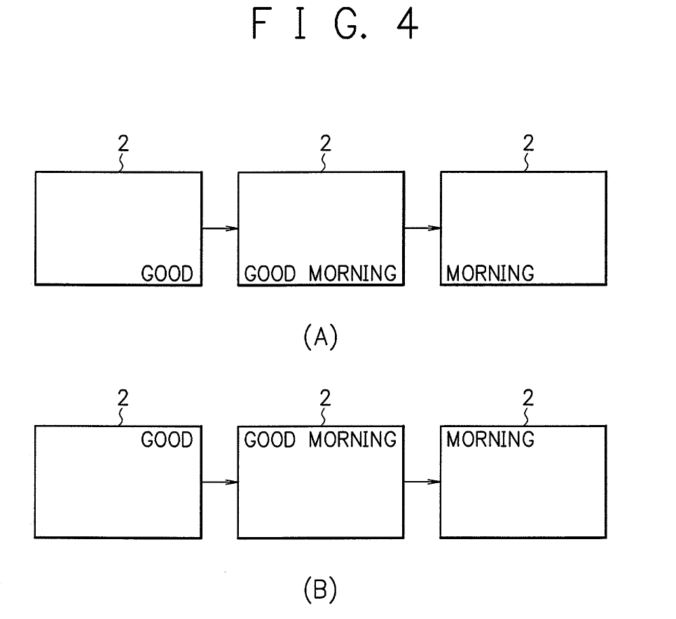

FIGS. 4 (A) and (B) are diagrams illustrating examples of horizontal display on the screen of FIG. 2 (B). In FIG. 4 (A), speech text is displayed moving from the left to the right with the same screen image (not shown) on the screen 2. This is effective to superimpose plural pieces of speech text on a screen image where it is necessary to display one speech text after another with prescribed time. While the speech text is displayed horizontally at the bottom of the screen in FIG. 4 (A), it can be displayed at the top of the screen as shown in FIG. 4 (B).

FIGS. 5 (A) and (B) are diagrams illustrating examples of vertical display on the screen of FIG. 2 (B). The operations of screen 2 in FIGS. 5 (A) and (B) are the same as those in FIGS. 4 (A) and (B). In FIG. 5 (A), text is displayed in vertical direction on the right of the screen, and in FIG. 5 (B), it is displayed on the left of the screen.

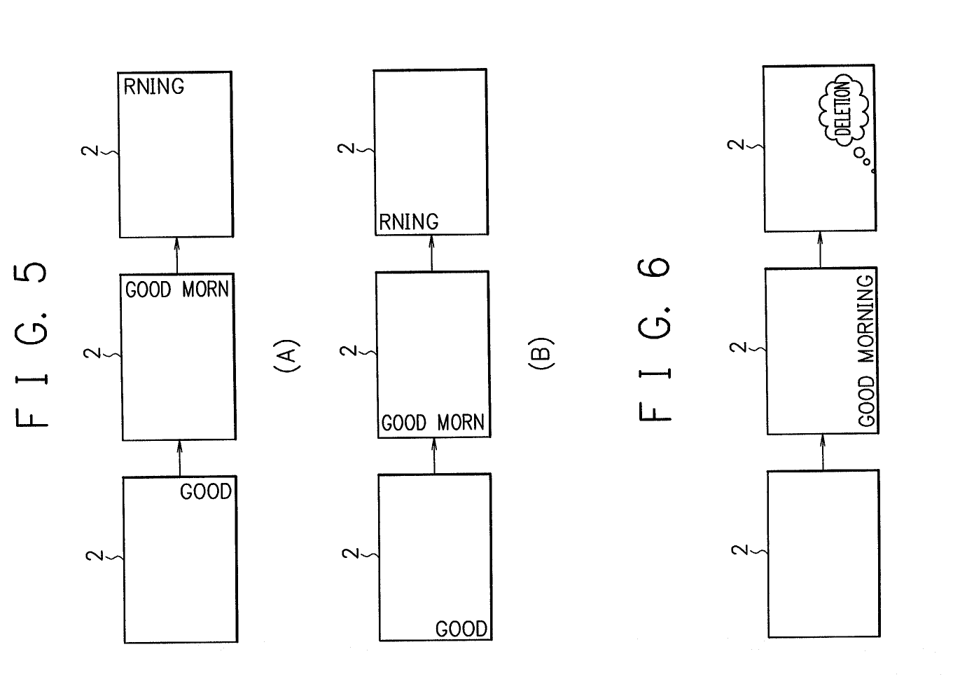

FIG. 6 is a diagram illustrating another example of horizontal display on the screen of FIG. 2 (B). Referring to FIG. 6, the speech text does not move on the screen 2, but is displayed in block for a predetermined period of time and disappears after the lapse of the time. When there are plural pieces of speech text for a screen image, the text may be displayed in plural lines on the screen 2.

Preferably, the above-mentioned speech text displays are program-controlled by the CPU 108. That is, by changing control data for controlling the text display data read position or text display output position, which are provided from the CPU 108 to the text display signal generating circuit 1054, each display style as shown in FIGS. 4 to 6 may be implemented. Additionally, it is possible to change the display speed as well as the location of text.

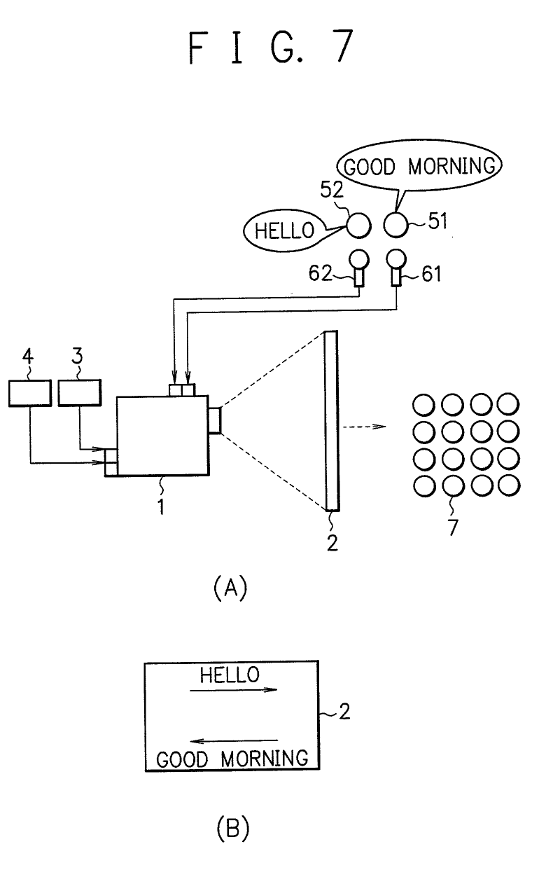

FIGS. 7 (A) and (B) are block diagrams showing the configuration of a system including a graphic display device according to the second embodiment of the present invention and a front view of a screen of the graphic display device, respectively. As can be seen in FIG. 7 (A), two microphones 61 and 62 are connected to the projector 1 so that speeches of two operators (speakers) 51 and 52 can be displayed on the screen 2. In this case, the projector 1 is further provided with two speech recognition circuits 1051 and two text buffer circuits 1052 in addition to the above-mentioned two speech input terminals 1050 shown in FIG. 3. Two audio signals can be processed and displayed as text at the same time by setting display order and a display type on a program at the CPU 108, namely, by providing processing routes corresponding to the number of the input terminals. In FIG. 6 (B), a speech of the first speaker 51 is displayed horizontally from the left to the right at the top of the screen 2 and a speech of the second speaker 52 is displayed from the right to the left at the bottom. Accordingly, the speeches of the speakers 51 and 52 can be displayed in the form of dialogue. The speech text may be displayed in one of the above-mentioned styles illustrated in FIGS. 4 to 6, or in a combination of these. Incidentally, much the same is true on the case where there are more than two operators.

While the preferred embodiments of the present invention have been explained by taking a projector, which is the most commonly used image display device in electronic presentations, as an example, the image display device according to the present invention is not limited to the projector. Image display devices such as a TV or a monitor may have the similar effect with a built-in speech display signal generating section 105 regardless of the system of the image display devices.

Besides, by changing control data for controlling the text display data read position, text display output position or the like, which are provided from the CPU 108 to the text display signal generating circuit 1054, the display speed as well as the location of text can be changed. Consequently, various types of display styles can be implemented. Thus, it is possible to produce visual effects in accord with the situations.

Additionally, by setting keywords to perform such operations as turning on/off the projector 1 or switching image input terminals 101 to the CPU 108 beforehand, each of the operations is executed when the CPU 108 finds the character code data equivalent to a keyword corresponding to the operation at the text buffer circuit 1052. As a result, an operator can control the operations without using a remote controller by speaking the keywords. In other words, it is possible to achieve the similar effect to that achieved by using a remote controller.

As set forth hereinabove, in accordance with the present invention, the image display device with a built-in speech recognition function is provided with a means for representing audio signals in characters as an auxiliary means of communicating operator's (speaker's) speech. Therefore, even in the circumstances where it is hard to hear operator's speech during electronic presentations, the contents of the presentations can be communicated to audiences in a convincing way. Namely, the presentations are not affected by external factors such as changes in surrounding noises or the way the operator (speaker) produces speech (pronunciation, speed, etc.), and thus constant communicability can be assured.

In addition, since the image display device of the present invention is provided with a means for representing audio signals in characters as a communication means, electronic presentations can be given without a loudspeaker system such as a speaker. Consequently, it is possible to reduce necessary devices, which lightens the workload of transporting the devices and setting operation such as connecting codes.

Moreover, since the image display device of the present invention is provided with a means for converting audio signals into visual information, it is possible to give electronic presentations to people with hearing difficulties, and realize electronic presentations in which more people can participate.

Furthermore, the image display device of the present invention can produce visual effects on electronic presentations by communicating audio signals visually as well as acoustically, and thus enabling more expressive electronic presentations.

While the preferred embodiments of the present invention have been described using specific terms, such description is for illustrative purposes only, and it is to be understood that changes and variations may be made without departing from the spirit or the scope of the following claims.

What is claimed is:

1. A graphic display device with a built-in speech recognition function, which converts speech to character codes to display it in combination with a screen image, comprising:
a speech display signal generating section for recognizing speech inputted from a microphone and generating a speech display signal;
an input image signal processing circuit for converting plural image inputs from analog to digital;
an image display memory for storing a digital image signal obtained at the input image signal processing circuit;
an image display signal generating circuit for reading the digital image signal stored in the image display memory and generating an image display signal;
a display signal combining circuit for combining the speech display signal outputted from the speech display signal generating section and the image display signal outputted from the image display signal generating circuit;
a CPU for controlling each circuit based on a program;
a memory control circuit for controlling the image display memory and the speech display signal generating section under the control of the CPU; and
a display section for displaying outputs from the display signal combining circuit on a screen.

2. The graphic display device with a built-in speech recognition function claimed in claim 1, wherein the speech display signal generating section includes:
a speech input terminal that is connected to the microphone;
a speech recognition circuit for recognizing an audio signal inputted to the speech input terminal and converting the signal to character code data;
a text buffer circuit for storing the character code data of the respective characters as text;
a font ROM for storing fonts;
a text display memory for converting the character code data to text display data and storing the data; and
a text display signal generating circuit for reading the text display data stored in the text display memory and generating a text display signal; and
wherein each of the circuits are connected through buses and controlled by the CPU and the memory control circuit.

3. The graphic display device with a built-in speech recognition function claimed in claim 1, wherein the CPU accesses to the font ROM when the text buffer circuit is supplied with character code data to convert the character code data to character pattern data, and feeds the data to the text display memory.

4. The graphic display device with a built-in speech recognition function claimed in claim 1, wherein the speech display signal generating section includes:
a speech input terminal that is connected to the microphone;
a speech recognition circuit for recognizing an audio signal inputted to the speech input terminal and converting the signal to character code data;
a text buffer circuit for storing the character code data of the respective characters as text;
a font ROM for storing fonts;
a text display memory for converting the character code data to text display data and storing the data; and
a text display signal generating circuit for reading the text display data stored in the text display memory and generating a text display signal; and wherein:
each of the circuits are connected through buses and controlled by the CPU and the memory control circuit; and
the CPU accesses to the font ROM when the text buffer circuit is supplied with character code data to convert the character code data to character pattern data, and feeds the data to the text display memory.

5. The graphic display device with a built-in speech recognition function claimed in claim 1, wherein the memory control circuit controls the image display memory and the text display memory so that speech text is synchronized with a screen image.

6. The graphic display device with a built-in speech recognition function claimed in claim 1, wherein the speech display signal generating section includes:
a speech input terminal that is connected to the microphone;
a speech recognition circuit for recognizing an audio signal inputted to the speech input terminal and converting the signal to character code data;
a text buffer circuit for storing the character code data of the respective characters as text;
a font ROM for storing fonts;
a text display memory for converting the character code data to text display data and storing the data; and
a text display signal generating circuit for reading the text display data stored in the text display memory and generating a text display signal; and wherein:
each of the circuits are connected through buses and controlled by the CPU and the memory control circuit; and
the memory control circuit controls the image display memory and the text display memory so that speech text is synchronized with a screen image.

7. The graphic display device with a built-in speech recognition function claimed in claim 1, wherein the speech display signal generating section includes:
plural speech input terminals for inputting speeches of plural speakers;
a speech recognition circuit for recognizing an audio signal inputted to the speech input terminal and converting the signal to character code data;
a text buffer circuit for storing the character code data of the respective characters as text;
a font ROM for storing fonts;
a text display memory for converting the character code data to text display data and storing the data; and
a text display signal generating circuit for reading the text display data stored in the text display memory and generating a text display signal; and wherein:
each of the circuits are connected through buses and controlled by the CPU and the memory control circuit; and
the speeches of plural speakers are independently displayed in characters on the screen.

8. The graphic display device with a built-in speech recognition function claimed in claim 1, wherein the speech display signal generating section includes:
plural speech input terminals for inputting speeches of plural speakers;
plural speech recognition circuits corresponding to the plural speech input terminals for recognizing audio signals inputted to the speech input terminals and converting the signals to character code data;
plural text buffer circuits corresponding to the plural speech input terminals for storing the character code data of the respective characters as text;
a font ROM for storing fonts;
a text display memory for converting the character code data to text display data and storing the data; and
a text display signal generating circuit for reading the text display data stored in the text display memory and generating a text display signal; and wherein:
each of the circuits are connected through buses and controlled by the CPU and the memory control circuit;
the speeches of plural speakers are independently displayed in characters on the screen; and
conversations of the plural speakers are displayed in the form of dialogue.
